(19) United States
(12) Patent Application Publication
(10) Pub. No.: US 2009/0034178 A1
(43) Pub. Date: Feb. 5, 2009

(54) FLAT-PANEL TV WALL SUPPORT WITH ADJUSTABLE VISUAL ANGLE

(76) Inventor: Jianrong Le, Ningbo (CN)

Correspondence Address: RABIN & Berdo, PC, 1101 14TH STREET, NW, SUITE 500, WASHINGTON, DC, 20005, US

(21) Appl. No.: 12/055,421

(22) Filed: Mar. 26, 2008

(30) Foreign Application Priority Data
Jul. 31, 2007 (CN) CN 200720112826.2

(51) Int. Cl. G06F 1/16

(52) U.S. Cl. 361/681

(57) ABSTRACT

A Flat-Panel TV Wall Support with adjustable visual angle, comprising a wall installing board, a TV fixing mechanism and an adjusting mechanism for adjusting the location of TV fixing mechanism; the TV fixing mechanism is connected with the wall installing board through the adjusting mechanism, wherein the adjusting mechanism comprises four movable arms, which forms a four bar linkage mechanism with mutual linkage capability and parallelogram top view projection, wherein the front end of the four bar linkage mechanism is movably connected with the TV fixing mechanism, while the tail end of the four bar linkage mechanism is movably connected with the wall installing board. Compared with prior art, the present invention has advantages of that: the four bar linkage mechanism makes the movement of TV more flexible, and needs less installation area. In addition, the TV fixing mechanism has extremely simple structure, ingenious application principle and better practicality.

### FIELD OF THE INVENTION

The present invention relates to a wall mounting mechanism used in plasma and LCD flat panel TVs, and more particularly to a Flat-Panel TV Wall Support with adjustable visual angle over a large range for different viewing distances, plane swing angle and tilt angle of screen.

### BACKGROUND OF THE INVENTION

With the rapid development of science and technology, plasma and LCD flat panel TVs are replacing traditional cathode ray tube TVs and entering common families. These new TVs are also used in information transmission and image projection for public places such as enterprises and institutions, hospital, stock exchange, station, wharf, airport and various transportation means. At present, the main installation methods of plasma and LCD flat panel TVs are supporting with chassis and hanging, and the viewing distance, plane swing angle and tilt angle of screen of most installed TVs can not be adjusted or only one of above functions can be adjusted. Therefore, the need of watching from different distances, directions and heights can not be satisfied; in addition, most traditional installing structures are splicing of reinforcing rods, wherein the installation steps are rather complicated. So the Chinese patent titled A Tilt-Type Flat Panel TV Wall Mount With Two Sections And Double Rocker Arms (patent number: 200620105341.6) discloses a structure, which comprises a wall panel board, left and right hanging plate and tilt-type adjusting mechanism, wherein the hanging plates are connected with a transition plate through tilt-type adjusting mechanism; the front face of transition plate is provided with two parallel hanging bars, while the tilt-type adjusting mechanism is hung on these two hanging bars; the back surface of transition plate is connected with wall panel board through a device with two sections and double rocker arms. The tilt-type adjusting mechanism comprises a hook-hanging device with one short arc groove and a screw; wherein, the device with two sections and double rocker arms comprises a pair of connecting riser fixed on the transition plate and a bearing support, and the outer swing arm, inner swing arm and a pair of left and right supporting arms fixed on wall panel board are hinged sequentially. The adjusting range for the tilt angle of this product is 0˜15 degree, while that of left and right swing angle is 30 degree. This product has the advantages of that: the structure is novel, the appearance is elegant, and the operation is flexible, thereby being widely used in the installation of big-screen flat panel TVs. But this product also has the following disadvantages: the front and rear ends of inner and outer swinging arms do not converge at a certain point but are installed separately, therefore not only the covering space is lager but also the left and right shift distances are limited, besides, the left and right turning angles are also limited, thus the flexibility is insufficient; in addition, the design is really complicated, the quantity of manufacture parts is large, and the assembly during installation is difficult, that is, the structure is neither reasonable nor simple, therefore the product should be further improved.

### SUMMARY OF THE INVENTION

The technical problem to be settled is to provide a Flat-Panel TV Wall Support with reasonable structure, convenient installation, large TV adjusting angle, higher flexibility and adjustable visual angle.

The technical solution to settle above problem of the present invention is that this Flat-Panel TV Wall Support with adjustable visual angle comprises a wall installing board, a TV fixing mechanism and an adjusting mechanism for adjusting the location of the TV fixing mechanism, wherein the TV fixing mechanism is connected with the wall installing board, wherein the adjusting mechanism comprises four movable arms, which forms a four bar linkage mechanism with mutual linkage capability and parallelogram top view projection, the front end of the four bar linkage mechanism is movably connected with the TV fixing mechanism, while the tail end of the four bar linkage mechanism is movably connected with the wall installing board.

As an improvement, the four bar linkage mechanism can be movably connected with the wall installing board, wherein the tail ends of two movable arms in rear are located in a same plane and movably arranged on the wall installing board side by side through respective stud shafts.

As a further improvement, the four bar linkage mechanism can be movably connected with the TV fixing mechanism, wherein the front ends of two movable arms are connected with a rotational component in the upper and lower positions, and the TV fixing mechanism is connected with the rotational component.

As a further improvement, the TV fixing mechanism comprises hanging bars and hanging plates, wherein the hanging bars are transversely arranged at the upper and lower positions and parallel to each other, the hanging plates are perpendicular to the hanging bars and parallel to each other, the hanging bars are connected with the hanging plates by bolts and screws, and the hanging bars is connected with the rotational component through the connecting plate, the flat panel TV is arranged on the hanging plate. Preferably, the number of the hanging bars are two, and the number of the hanging plates are also two, the two hanging bars are connected with the two hanging plates in “#” shape, wherein each hanging bar is provided with T-shape grooves which can adjust the transversal position of the hanging plates on hanging bar and make installation easier, while each hanging plate is designed as folded plate which can make installation easier and safer.

As a further improvement, the rotational component is in hollow cylinder shape, the front end of the movable arms of the four bar linkage mechanism is rotatably arranged at the periphery of the cylinder-shape rotational component, the connecting plate is a curved board, which cross rotatablely through the cylindrical inner cavity of the rotational component, the connecting plate is locked by the positioning fastener in the inner cavity of the rotational component, and the upper and lower ends of the connecting plate are connected with the middle positions on the back surface of the corresponding upper and lower hanging bars through screws and bolts.

As a further improvement, the wall installing board is connected with the wall through expansion screws, welding or the like as required.

As a further improvement, to make the appearance more beautiful, a wire furling device can be arranged at the lower position of movable arms; the wire furling device may comprises an upper wiring cover, a lower wiring cover and a wiring clip, the upper wiring cover is connected with the lower surface of one of the movable arms, and the wire is furled and fixed in corresponding position of the upper wiring cover; the lower wiring cover is connected with the upper wiring cover through a buckle.

Compared with prior art, the present invention adopt four movable arms to form a four bar linkage mechanism with mutual linkage capability and parallelogram top view projection, wherein the front end of the four bar linkage mechanism is movably connected with the TV fixing mechanism, while the tail end of the four bar linkage mechanism is movably connected with the wall installing board. This design has advantages of that: the parallelogram four bar linkage mechanism makes the movement of TV more flexible as well as provides larger displacement distance; The rear ends of the four bar linkage mechanism is mainly converged at a certain point, therefore the installation area of wall surface is small, and so is the covering space. For example, when the TV is moved to left by four bar linkage mechanism, the right space will be vacated, and vice versa, therefore the utilization rate of space becomes higher; in addition, the present TV fixing mechanism only comprises two hanging bars, two hanging plates and one rotational component, therefore this mechanism has extremely simple structure, ingenious application principle and better practicality.

### BRIEF DESCRIPTION OF THE DRAWINGS

FIG. 1 is the structure scheme of the present invention;

FIG. 2 is the exploded view of FIG. 1;

FIG. 3 is the front projection view of FIG. 1;

FIG. 4 is the back view of FIG. 3;

FIG. 5 is the left view of FIG. 3;

FIG. 6 is the top view of FIG. 3;

FIG. 7 is the enlarged view of the Part I of FIG. 2.

### DETAILED DESCRIPTION OF THE PREFERRED EMBODIMENT

The detailed description of the present invention is followed in conjunction with the figures.

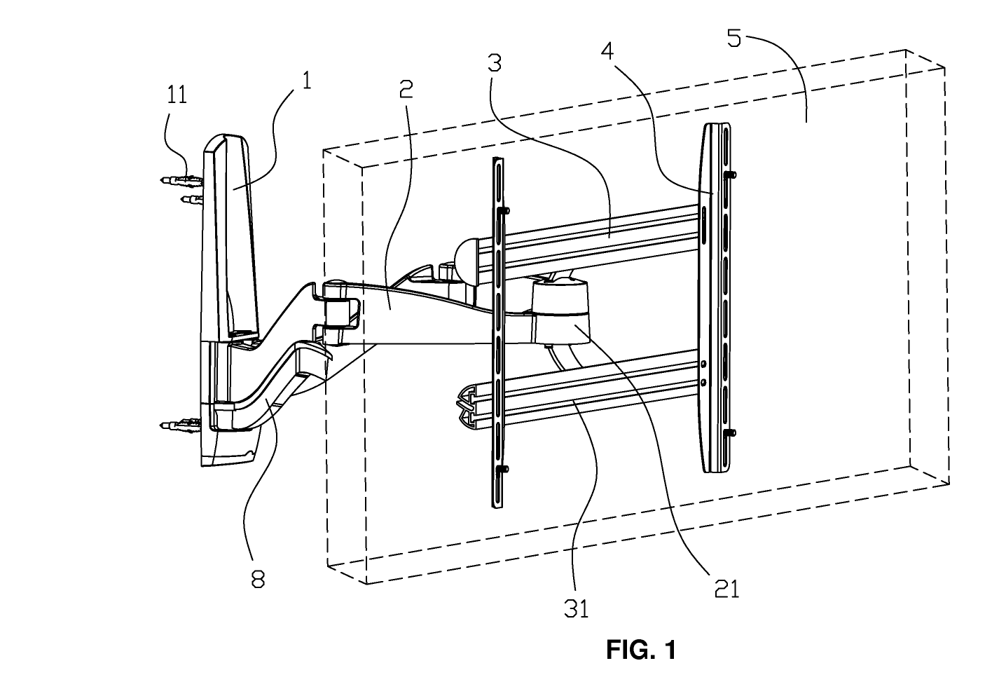

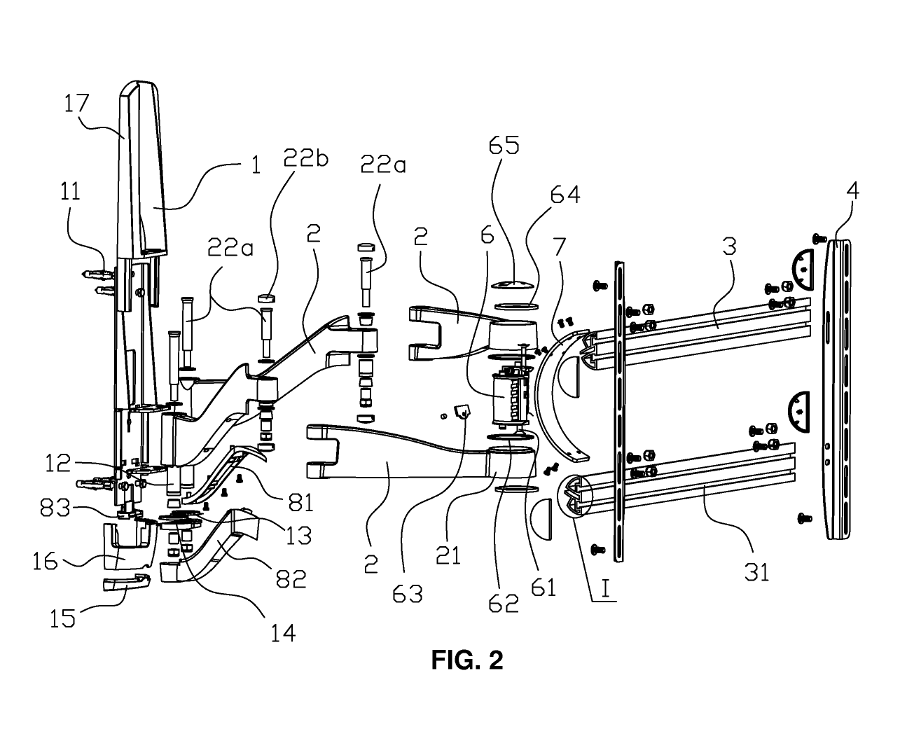

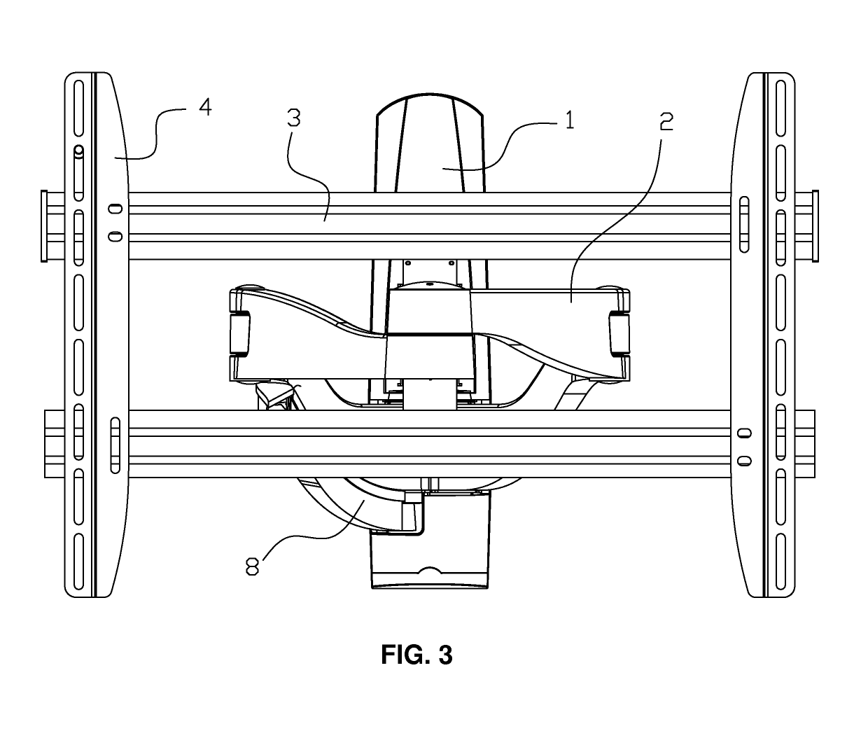

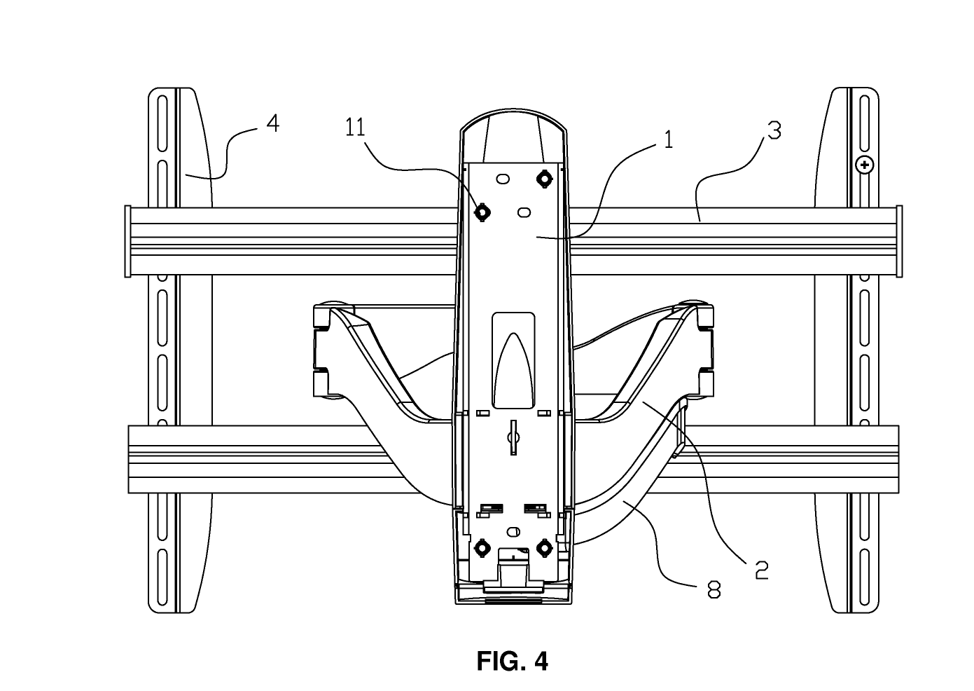

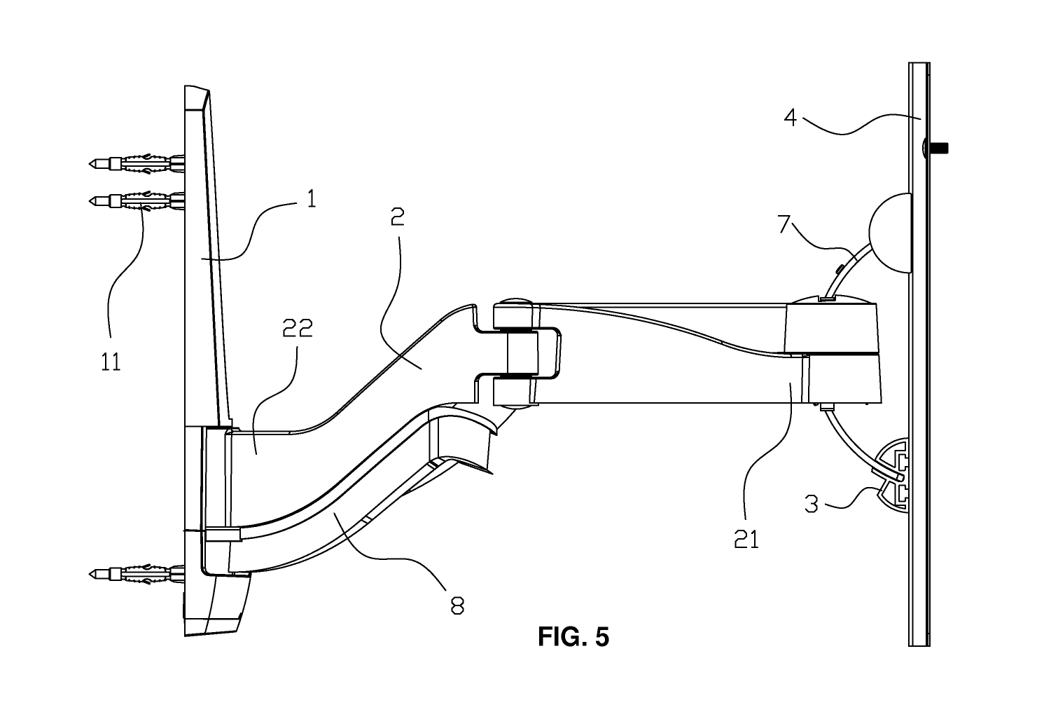

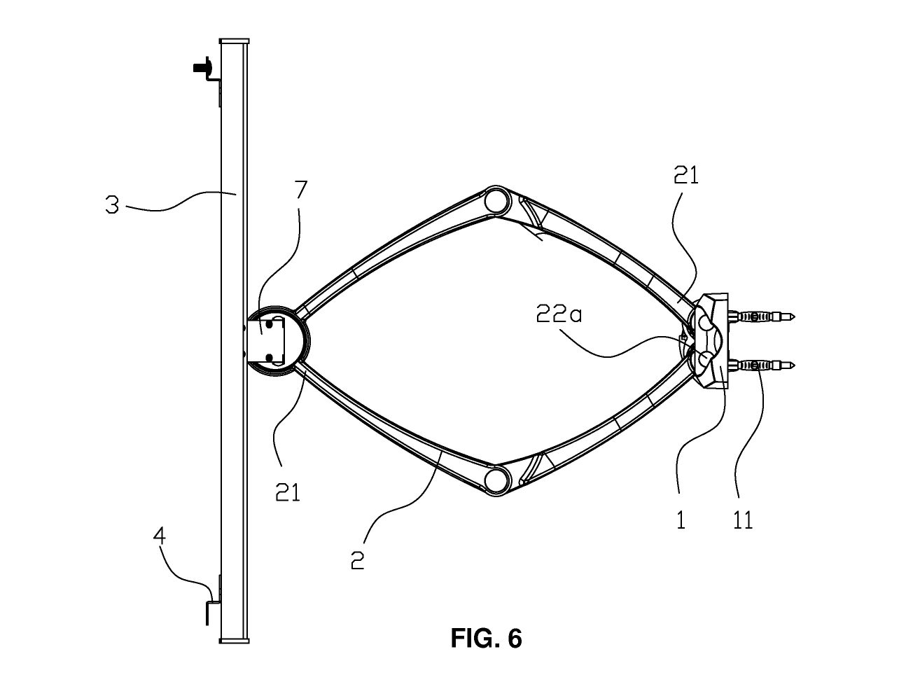

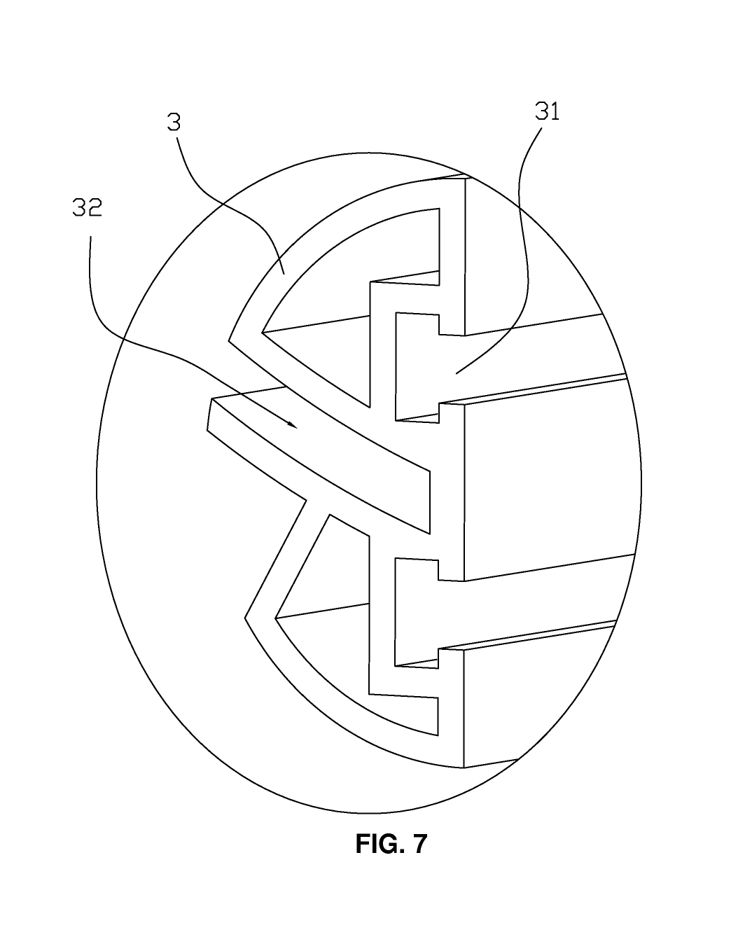

FIG. 1 to 7 shows that the Flat-Panel TV Wall Support with adjustable visual angle of the present invention, comprises a wall installing board 1, a TV fixing mechanism and an adjusting mechanism for adjusting the position of the TV fixing mechanism; wherein, the TV fixing mechanism is connected with the wall installing board 1 through the adjusting mechanism. The adjusting mechanism comprises four movable arms 2, which forms a four bar linkage mechanism with mutual linkage capability and parallelogram top view projection, wherein the front end 21 of the four bar linkage mechanism is movably connected with the TV fixing mechanism, while the tail end 22 of the four bar linkage mechanism is movably connected with the wall installing board 1. The tail ends 22 of the two movable arms 2 in rear are located in a same plane and swing arranged on the wall installing board 1 side by side through respective stud shafts 22a, therefore the installing area on the wall surface is reduced effectively; the front ends 21 of the two movable arms 2 in front of the parallel four bar linkage mechanism are connected with a rotational component 6 in the upper and lower positions, and the TV fixing mechanism is connected with the rotational component 6. The TV fixing mechanism comprises hanging bars 3 and hanging plates 4, wherein the hanging bars 3 are transversely arranged at the upper and lower positions and parallel to each other, the hanging plates 4 are perpendicular to the hanging bars 3 and parallel to each other, the hanging bars 3 are connected with hanging plates 4 by bolts or screws, the hanging bar 3 is connected with the rotational component 6 through the connecting plate 7, and flat panel TV is arranged on the hanging plate 4. The number of the hanging bars 3 is two, the number of the hanging plates is also two, and the two hanging bars are connected with the two hanging plates 4 in “#” shape, wherein each hanging bar 3 is provided with T-shape grooves 31 which can adjust the transversal position of the hanging plate 4 on hanging bar 3 and make installation easier, while each hanging plate 4 is designed as folded plate which can make installation easier and safer, as shown in FIG. 6. The rotational component 6 is in hollow cylinder shape, as shown in FIG. 2, the front end 21 of the movable arms 2 in the four bar linkage mechanism is rotatablely arranged at the periphery of the cylinder-shape rotational component 6, the connecting plate 7 is a curved board, which crosses rotatablely through the cylindrical inner cavity of the rotational component 6, and the upper and lower ends of the connecting plate 7 are connected with the middle positions on the back surface of the corresponding upper and lower hanging bars 3 through screws or bolts. The wall installing board 1 is fixed on the wall by expansion screws 11. Of course, it could be fixed on the wall by other means such as welding as required. The lower position of the movable arms 2 is provided with a wire furling device 8. The wire furling device 8 comprises an upper wiring cover 81, a lower wiring cover 82 and a wiring clip 83, the upper wiring cover 81 is connected with the lower surface of one of the movable arm 2 by a screw, and the wire is furled and fixed in corresponding position of the upper wiring cover 81; the lower wiring cover 82 is connected with the upper wiring cover 81 through a buckle. The wire is hidden and the wiring clip 83 is inserted into the bottom of installing board 1. The wire can be furled through wire groove.

The followings are detailed descriptions for the present invention.

As shown in FIGS. 1 to 7, the four bar linkage mechanism comprises movable arms 2, bolt axes connector, a conical bearing assembly and a joggle gear synthronous subassembly. Wherein, the movable arms 2 comprises left and right rear arms and left and right front arms, which are connected together by the bolt axes and form a retractable gemel structure. The bolt axes connector comprises bolt axes 22a, a spacer and a fastening nut; The conical bearing assembly comprises a plastic shaft housing and a conical bearing 12, wherein the bolt axes connector and the conical bearing assembly form the rotational component; The joggle gear synthronous subassembly comprises a set of locating joggle gears 13 and gear spacers 14, wherein the synchronization stretch of left and right arms are realized through the interjoggling of the locating joggle gears, and the gear spacers 14 is located at the bottom of gears so as to reduce the locomotion resistance.

The regulations of the plane swinging angle and tilt angle of the screen are realized through rotational component 6, sliding block 61, conical washer 64, flat type washer 62, taper type bolt & nut, orientation fastening part 63, cone screw, stop screw and decorative cover 65. After being assembled, the rotational component 6, conical washer 64, flat type washer 62 and taper type bolt & nut are inserted into the hole in butt joint position of the left and right arms. The tightness of whole assembly rotating in the hole of butt joint position is adjusted through the tightness of the double screw and nut on cone head; the sliding block 61 may slide into the corresponding sliding groove on the rotational component 6 and slide with front and back tilt angle of the screen; The orientation fastening part 63 is disposed in the corresponding groove of the rotational component 6 and performs the orientation of the connecting plate 7 through the regulation of cone screw. The TV fixing mechanism comprises hanging bars 3, vertical hanging plates 4 and installing fastener. The hanging bars 3 is embedded in groove 32 and connected with the connecting plate 7 by a fastener; the hanging plate 4 is connected with corresponding T-type groove 31 on the hanging bar 3 through a fastener, and also can be used for connecting the flat panel TV 5 through fasteners.

In order to reduce the overall dimension of the wall support, the hanging bar 3 and the hanging plate 4 can be replaced by plate-type structure during installation of small flat panel TV The specific dimensions can be decided by design plan. The wall installing board comprises an upper cover 17, a lower cover 16 and a bottom cap 15, which are connected together to form a whole body and enhance the beauty of appearance; The hinge hole cover 22b can cover the corresponding hole in movable arm 2 and improve the appearance.

What is claimed is:

1. A Flat-Panel TV Wall Support with adjustable visual angle, compriseing a wall installing board (1), a TV fixing mechanism and an adjusting mechanism for adjusting the location of TV fixing mechanism; the TV fixing mechanism is connected with the wall installing board (1) through the adjusting mechanism, wherein the adjusting mechanism comprises four movable arms (2), which forms a four bar linkage mechanism with mutual linkage capability and parallelogram top view projection, wherein the front end (21) of the four bar linkage mechanism is movably connected with the TV fixing mechanism, while the tail end (22) of the four bar linkage mechanism is movably connected with the wall installing board (1).

2. The Flat-Panel TV Wall Support with adjustable visual angle recited in claim 1, wherein the structure which the four bar linkage mechanism is movably connected with the wall installing board (1) is that, the tail ends (22) of the two movable arms (2) in rear are located in a same plane and movably arranged on the wall installing board (1) side by side through respective stud shafts (22a).

3. The Flat-Panel TV Wall Support with adjustable visual angle recited in claim 2, wherein the structure which the four bar linkage is movably connected with the TV fixing mechanism is that, the front ends (21) of two movable arms (2) are connected with a rotational component (6) in the upper and lower positions, and the TV fixing mechanism is connected with the rotational component (6).

4. The Flat-Panel TV Wall Support with adjustable visual angle recited in claim 3, wherein the TV fixing mechanism comprises hanging bars (3) and hanging plates (4), in which the hanging bars are transversely arranged at the upper and lower positions and parallel to each other, the hanging plates are perpendicular to the hanging bars and parallel to each other, the hanging bars (3) are connected with the hanging plates (4) by bolts or screws, the hanging bars (3) is connected with the rotational component (6) through a connecting plate (7), and the flat-panel TV is arranged on the hanging plate (4).

5. The Flat-Panel TV Wall Support with adjustable visual angle recited in claim 4, wherein the number of the hanging bars (3) are two, and the number of the hanging plates (4) are also two, the two hanging bars (3) are connected with two hanging plates (4) in “#” shape, wherein each hanging bar (3) is provided with T-shape grooves (31) which can adjust the transversal position of the hanging plate (4) on hanging bar (3) and make installation easier, while each hanging plate (4) is designed as folded plate which can make installation easier and safer.

6. The Flat-Panel TV Wall Support with adjustable visual angle recited in claim 4, wherein the rotational component (6) is in hollow cylinder shape, the front end (21) of the movable arms (2) in the four bar linkage mechanism is rotatablely arranged at the periphery of the cylinder-shape rotational component (6), the connecting plate (7) is a curved board, which cross movably through the cylindrical inner cavity of the rotational component (6), the connecting plate (7) is locked by the locating fastener (63) in the inner cavity of the rotational component (6), and the upper and lower ends of the connecting plate (7) are connected with the middle positions on the back surface of the corresponding upper and lower hanging bars (3) through screws or bolts.

7. The Flat-Panel TV Wall Support with adjustable visual angle recited in claim 1, wherein the wall installing board (1) is fixed on the wall through expansion screws (11) or by welding.

8. The Flat-Panel TV Wall Support with adjustable visual angle recited in claim 1, wherein the lower position of the movable arms (2) is provided with a wire furling device (8).

9. The Flat-Panel TV Wall Support with adjustable visual angle recited in claim 8, wherein the wire furling device (8) comprises an upper wiring cover (81), a lower wiring cover (82) and a wiring clip (83), the upper wiring cover (81) is connected with the lower surface of one of the movable arm (2), and the wire is furled and fixed in corresponding position of the upper wiring cover (81); the lower wiring cover(82) is connected with the upper wiring cover (81) through a buckle.
